(19) United States
(12) Patent Application Publication
(10) Pub. No.: US 2004/0263942 A1
(43) Pub. Date: Dec. 30, 2004

(54) Display system allowing enhanced dynamic range

(76) Inventors: Matthew Grant Lopez, Escondido, CA (US); Nancy Eng Wilson, Corvallis, OR (US); John F. Wilson, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/603,381

(22) Filed: Jun. 24, 2003

(51) Int. Cl. G02F 1/01

(52) U.S. Cl. 359/277

(57) ABSTRACT

The present invention provides a first pixel array and a second pixel array disposed along an optical path. The first pixel array is adapted to generate an image. The second pixel array is adapted to adjust an output luminescence of the image.

### BACKGROUND

Conventional digital projection devices commonly utilize a single layer LCD (Liquid Crystal Display) array consisting of RGB (Red, Green, Blue) pixels. Light from a spectrally broad illumination source, such as a light bulb, is collected by a condensing lens and is directed toward a spatial light modular system having addressable rows and columns of RGB pixels. The spatial light modular system controls the amount of light transmitted through each pixel electronically to provide a desired luminescence. A projection lens then images the resulting transmitted light from the array of pixels in the spatial light modular system on a viewing screen or other display.

Each RGB pixel is divided into three sub-pixels having equal areas. Each sub-pixel is covered with a micro-color filter having a different spectral transmittance: red, green and blue. The transmittance of each sub-pixel is then controlled independently, resulting in the ability to display a color image.

While such a system allows projection and display of color images, difficulties exist with respect to luminescence of the projected image. Specifically, due to current technology, the dynamic range of the projected image has limitations. In such digital display devices, high luminescent colors are generated at the cost of clipping low luminescence values. Or, the dynamic range is shifted downward to prevent clipping of low luminescent colors at the expense of high luminescent colors. The present invention was developed in light of these and other drawbacks.

### SUMMARY

The present invention provides a first pixel array and a second pixel array disposed along an optical path. The first pixel array is adapted to generate an image. The second pixel array is adapted to adjust an output luminescence of the image.

Other aspects of the invention will be apparent to those skilled in the art after reviewing the drawings and the detailed description below.

### BRIEF DESCRIPTION OF THE DRAWINGS

The present invention will now be described, by way of example, with reference to the accompanying drawings, in which:

FIG. 1 is a schematic view of a display device according to an embodiment of the present invention;

FIG. 2A is a schematic view of a pixel array for a display device according to an embodiment of the present invention;

FIG. 2B is a schematic view of a pixel for a display device according to an embodiment of the present invention;

FIG. 3A is a schematic view of a pixel array for a display device according to an embodiment of the present invention;

FIG. 3B is a schematic view of a pixel for a display device according to an embodiment of the present invention; and

FIG. 4 is a graphical view illustrating a range of luminance of the display device according to the present invention.

### DETAILED DESCRIPTION

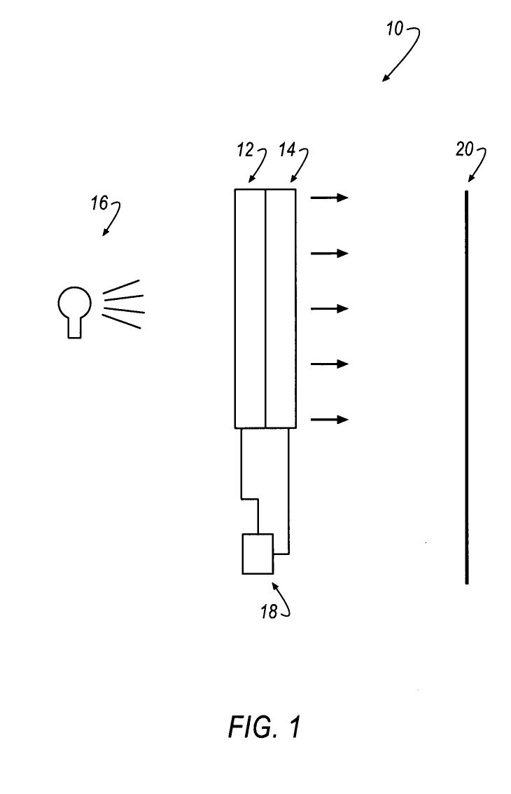

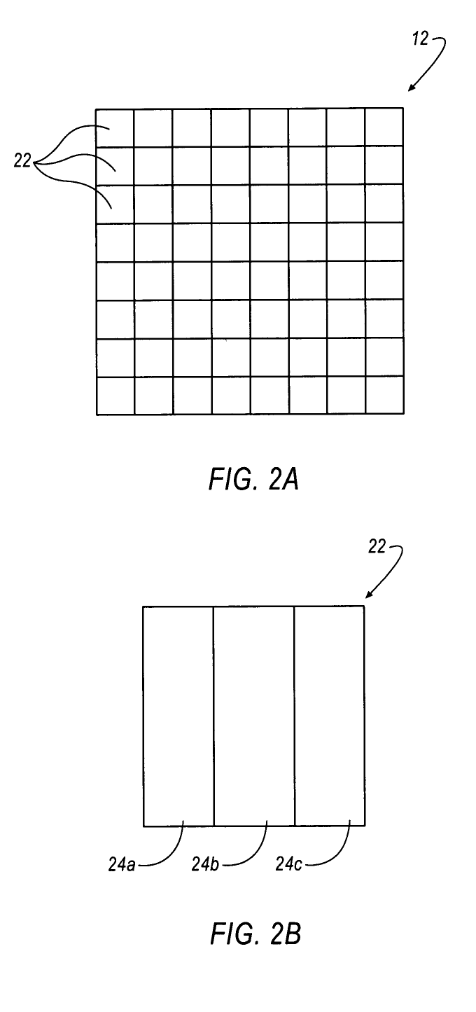

Referring now to FIG. 1, a display device 10 according to an embodiment of the present invention is shown and described. Display device 10 generally includes image pixel array 12, luminance pixel array 14, illumination source 16, processor 18 and display 20. Referring to FIGS. 2A and 2B, image pixel array 12 preferably includes a two-dimensional array of RGB (red, green, blue) pixels 22. Although the present embodiment is illustrated with RGB pixels, it is understood that other colors and arrangements, including black, are possible, and the present invention is not limited to that disclosed herein.

RGB pixels 22 include red portion 24a, green portion 24b and blue portion 24c. Each portion 24a, 24b and 24c are responsive to processor 18 to control the transmittance of light from illumination source 16. The processor is merely representative of any control device, and can include any of the pixel arrays themselves instead of being a separate component as shown. By adjusting the transmittance of each portion 24a, 24b and 24c, illumination at the output of each RGB pixel 22 can be adjusted to generate any desired color therefrom. By independently adjusting portions 24a, 24b and 24c, a desired colored image is created.

Illumination source 16 is a light bulb or any other source of illumination that generates spectrally broad light (i.e., white light). The illumination source 16 preferably works in conjunction with pixels 22 to generate an image. Illumination source 16 provides the requisite light that is transmitted through the pixels 22 to transmit the image to a destination external to RGB pixels 22.

It will be understood that luminance pixel array 14 and image pixel array 12 can be in any order with respect to illumination source 16 and the destination. For example, luminance pixel array 14 can be positioned next to illumination source 16, allowing image pixel array 12 to receive light from the luminance pixel array 14. Or, image pixel array 12 can be positioned proximate illumination source 16, allowing luminance pixel array 14 to receive light from image pixel array 12.

Display 20 can be any known display including a projection screen, laptop or other computer display, projection screen for a projector or any other known display. One skilled in the art will readily recognize that other suitable displays and projection devices may be employed in conjunction with the present invention, and that the present invention is not limited by that disclosed herein.

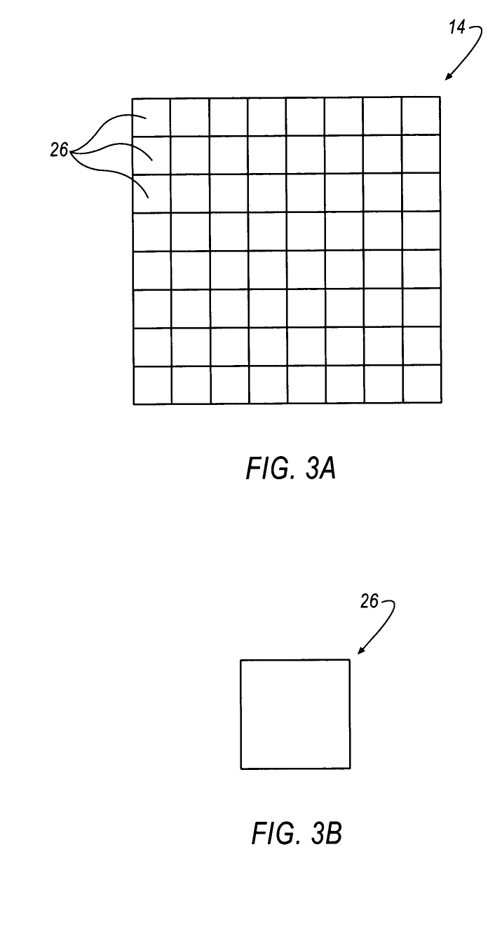

Luminance pixel array 14 (Shown in FIGS. 3A and 3B) is positioned adjacent image pixel array 12. Although the present embodiment shows image pixel array 12 adjacent to and abutting luminance pixel array 14, it is understood that the present invention preferably positions image pixel array 12 and luminance pixel array 14 along the same optical path. Therefore, one skilled in the art will readily understand that optical components, such as mirrors or lenses, may additionally be positioned between image pixel array 12 and luminance pixel array 14 to direct light along the optical path from the image pixel array 12 to the luminance pixel array 14.

Luminance pixel array 14 generally includes a plurality of pixels 26. As shown in FIG. 3B, a preferred embodiment of each pixel 26 is a monochromatic pixel that adjusts the transmission of light therethrough to reduce or block light transmitted from image pixel array 12. Although pixels 26 are preferably monochromatic in nature, it will be understood by one skilled in the art that pixels 26 can be any known transmission control device for reducing or enhancing optical transmission and that the present invention is not limited by that disclosed herein.

With reference to FIGS. 1-4, the operation of the present invention will be shown and described. In operation, light generated from illumination source 16 is projected on image pixel array 12. Although not shown, a focusing element, such as a lens, may be employed between illumination source 16 and image pixel array 12 to focus the light on array 12 in a desired fashion. Processor 18 communicates with the pixel array of array 12 to adjust the color of light passing through each pixel for providing and outputting a desired color image therefrom. The colored image from image pixel array 12 is then projected along the optical path to luminance pixel array 14. Each of the pixels 26 of array 14 then, if desired and instructed by processor 18, changes luminescence of the light projected from image pixel array 12. Preferably, luminance pixel array 14 is positioned adjacent and abutting image pixel array 12, such that each of the plurality of pixels of image pixel array 12 is directly aligned with a respective one of the plurality of pixels from luminance pixel array 14. By this way, each pixel 26 of luminance pixel array 14 controls luminescence from a respective pixel 22. This allows independent control over luminescence of each individual pixel 22 of image pixel array 12.

Preferably, each pixel 26 enhances, adjusts, reduces or blocks illumination from respective pixels 22 in array 12. Most preferably, each pixel 22 is a LCD (liquid crystal display) pixel that adjusts the transmission of light therethrough. Thus, the luminescence of light projected onto luminance pixel array 14 is then illuminated onto display 20 for viewing.

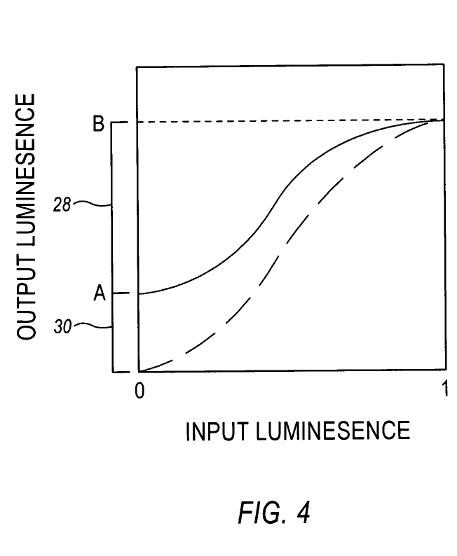

With reference to FIG. 4, the output luminescence from luminance pixel array 14 is shown in conjunction with the input luminescence provided by illumination source 16. The output from the luminance pixel array 14 is illustrated by the ordinate of the graph, while the input or illumination of illumination source 16 is represented by the abscissa. Likewise, adjustment of luminescence with both the input to illumination source 16 and luminance pixel array 14 is represented by the dashed line, while adjustment without pixel array is represented by the solid line. Range 28 illustrates the effective output luminescence from array 12 without enhancement by luminance pixel array 14. Specifically, adjustment of the energy to illumination source 16 between 0 and 1 will result in an output luminescence that ranges between 0 and B. As can be seen, the output luminescence reaches a peak value at 1 and falls to a minimum value at 0. However, once the input luminescence comes close to 0, the output luminescence immediately drops to 0 in a stepwise fashion. Thus, controlling luminescence between 0 and A is difficult at best. However, when used in conjunction with array 14, range 30 is employed and applied to the overall dynamic range of the system. As such, for example, when an output luminescence of closer to 0 is desired for any given pixel, any or all of the respective pixels 26 of array 14 can be employed to further reduce the output luminescence from value A to 0 as shown by line 30. It should be noted that all the pixels can be reduced to reduce the overall luminescence of the image. Or, a portion can be adjusted, such a for darker colors, to increase contrast.

While the present invention has been particularly shown and described with reference to the foregoing preferred and alternative embodiments, it should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

What is claimed as new and desired to be protected by Letters Patent of the United States is:

1. A spatial light modulator, comprising:
a first pixel array; and
a second pixel array disposed along a same optical path as the first pixel array;
wherein the first pixel array is adapted to adjust colors of light transmitted through pixels in the first pixel array to generate an image; and
wherein the second pixel array is adapted to filter the image transmitted from the first pixel array to adjust an output luminescence of the image.

2. The spatial light modulator according to claim 1, wherein the first pixel array comprises a plurality of colored pixels.

3. The spatial light modulator according to claim 2, wherein each of the colored pixels includes a red portion, green portion and blue portion.

4. The spatial light modulator according to claim 3, wherein each of the colored pixels is adapted to adjust the red portion, green portion and blue portion to create a desired color.

5. The spatial light modulator according to claim 1, wherein:
the first pixel array is positioned adjacent to the second pixel array;
each of a plurality of first pixels of the first pixel array are aligned to each of a plurality of second pixels of the second pixel array; and
light from each of the first pixels is filtered by a respective one of the second pixels.

6. The spatial light modulator according to claim 5, wherein the first pixel array is positioned along the optical path before the second pixel array with respect to an illumination source.

7. The spatial light modulator according to claim 1, wherein the second pixel array comprises a plurality of monochromatic pixels.

8. A display device comprising:
an illumination source;
a first pixel array;
a second pixel array disposed along a same optical path as the first pixel array;
a display; and
a control device that communicates with at least the first pixel array and the second pixel array;
wherein the first pixel array and the second pixel array are disposed along the optical path between the illumination source and the display;
wherein the control device is adapted to communicate with the first pixel array to adjust colors of light transmitted through pixels in the first pixel array to generate an image; and
wherein the control device is adapted to communicate with the second pixel array filters the image transmitted from the first pixel array to adjust an output luminescence of the image.

9. The display device according to claim 8, wherein the first pixel array comprises a plurality of colored pixels.

10. The display device according to claim 9, wherein each of the colored pixels includes a red portion, green portion and blue portion.

11. The display device according to claim 10, wherein the processor is adapted to communicate with each of the colored pixels to adjust the red portion, green portion and blue portion to create a desired color.

12. The display device according to claim 8, wherein:
the first pixel array is positioned adjacent to the second pixel array;
each of a plurality of first pixels of the first pixel array are aligned to each of a plurality of second pixels of the second pixel array; and
light from each of the first pixels is filtered by a respective one of the second pixels.

13. The display device according to claim 12, wherein the first pixel array is positioned along the optical path before the second pixel array with respect to an illumination source.

14. The display device according to claim 8, wherein the second pixel array comprises a plurality of monochromatic pixels.

15. The display device according to claim 8, wherein the display is a screen of a computer.

16. The display device according to claim 8, wherein a display is a projector screen.

17. A method for controlling luminescence of an image comprising:
providing a first pixel array and a second pixel array;
positioning the second pixel array along an optical path with the first pixel array;
controlling the first pixel array to generate an image on the second pixel array; and
controlling the second pixel array to adjust luminescence of the image and project the image on a display.

18. The method according to claim 17, wherein the first pixel array comprises a plurality of colored pixels.

19. The method according to claim 18, wherein the second pixel array comprises a plurality of monochromatic pixels.

20. The method according to claim 18, wherein the second pixel array expands a dynamic range of a display device containing the first pixel array, second pixel array and display.

21. A display device comprising:
a first pixel array means for generating an image;
a second pixel array means for adjusting an illumination of the image;
wherein a dynamic range of the display is enhanced.

22. A method for controlling luminance of an image comprising:
providing a luminance pixel array;
positioning the luminance pixel array along an optical path with an image pixel array;
controlling the luminance pixel array to adjust luminescence of an image projected by the image pixel array on a display.

23. The method according to claim 22, wherein the luminance pixel array comprises a plurality of monochromatic pixels.

24. The method according to claim 23, wherein the luminance pixel array expands a dynamic range of the image pixel array.
